(19) United States
(12) Patent Application Publication
(10) Pub. No.: US 2019/0329665 A1
(43) Pub. Date: Oct. 31, 2019

(54) Cable Bearing Arrangement and Method of Installing a Cable Bearing Arrangement

(71) Applicant: Bombardier Primove GmbH, Berlin (DE)

(72) Inventors: Éanna Curran, Darmstadt (DE); Sergio Alejandro Perez Romero, Alsbach-Haehnlein (DE)

(21) Appl. No.: 16/311,489

(22) PCT Filed: Jun. 26, 2017
(86) PCT No.: PCT/EP2017/065651

§ 371 Date: Dec. 19, 2018

(30) Foreign Application Priority Data
Jun. 28, 2016 (GB) 1611191.6

(51) Int. Cl. B60L 53/38; H02G 11/00; B60L 53/12

(52) U.S. Cl. CPC B60L 53/38; B60M 7/00; B60L 53/12; H02G 11/006

(57) ABSTRACT

The invention relates to a cable bearing arrangement for a winding structure of system for inductive power transfer, wherein the winding structure has at least a first cable, wherein the cable bearing arrangement comprises or provides at least one cable guiding means for holding at least the first cable, wherein the cable bearing arrangement is provided by a cable chain, wherein the cable chain can adopt an unrolled state and a rolled-up state and a method of installing a cable bearing arrangement.

The invention relates to a cable bearing arrangement for a winding structure of a system for inductive power transfer. Furthermore, the invention relates to a method of installing such a cable bearing arrangement.

While travelling on a route, a vehicle requires energy for driving (i.e. propulsion) and/or for auxiliary equipment which does not produce propulsion of the vehicle. Such auxiliary equipment includes, for example, lighting systems, heating and/or air conditioning systems, ventilation and passenger information systems. Not only track-bound vehicles (such as trams), but also road automobiles can be operated using electric energy. If continuous electric contact between the travelling vehicle and an electric rail or wire along the route is not desired, electric energy can be either withdrawn from an on-board energy storage or can be received by induction from an arrangement of electric lines of the route.

The transfer of electric energy to the vehicle by induction forms a background of the invention. A route-sided conductor arrangement (primary side) produces an electromagnetic field. The field is received by a vehicle-sided conductor arrangement (secondary side), e.g. a coil, on board of the vehicle so that the field produces an electric voltage by induction. The transferred energy may be used for propulsion of the vehicle and/or for other purposes such as providing the auxiliary equipment of the vehicle with energy. The vehicle may be, for example, a vehicle having an electrically operated drive motor. However, the vehicle may also be a vehicle having a hybrid drive system, e.g. a system which can be operated by electric energy or by other energy, such as energy provided using fuel (e.g. natural gas, diesel fuel, petrol or hydrogen).

The focus of the present invention is to continuously transfer energy to the vehicle while it travels or stands on the route. WO 2010/031596 A2 discloses a shaped block for positioning and/or holding a plurality of line sections of one or more electric lines along a driving way of a vehicle, wherein the shaped block has a plurality of recesses and/or projections, wherein the edges of a recesses and/or projections for the line sections in each case form a boundary of a space into which one of the line sections can be brought, so that it extends in a longitudinal direction of the space, and wherein the longitudinal directions of the spaces, delimited by the edges of the recesses and/or by the projections, extend essentially parallel to one another in a common plane.

If an alternating electric current flows through the electric lines, an electromagnetic field is produced that induces an electric current in a receiver of a vehicle which is travelling on the driving way. The shaped blocks facilitate the laying of electric lines in the driving way.

WO 2010/031596 A2 discloses ways of integrating the shaped block in railways for rail vehicles. For example, the shaped blocks are placed in between the rails, the electric lines are laid into the spaces defined by the blocks and the blocks are covered by lids.

For providing a primary winding structure or a secondary winding structure of a system for inductive power transfer one or more cables need to be arranged in a specific geometry, in particular such that the winding structure provided by the cable geometry is able to generate an electromagnetic field for power transfer or for receiving an electromagnetic field for power transfer. Further, it is desirable to provide a portable and easy-to-deploy cable bearing arrangement, by which a stable arrangement of the cables is provided. Further, precise installation of the cable bearing arrangement is desired.

WO 2014/037324 A2 discloses a pavement slab assembly which comprises a cable bearing arrangement adapted to position and/or to hold a plurality of line sections of one or more electric lines.

WO 2013/007823 A3 discloses the usage of pre-fabricated shaped modules to place the shaped modules and the at least one electric line on site where the route is to be built and to cover the shaped blocks and the electric line or lines by a cover layer of the route.

WO 2014/072373 A1 discloses a two-level cable bearing arrangement which can also be referred to as winding housing.

There is the technical problem of providing a cable bearing arrangement and a method of installing a cable bearing arrangement which allow a precise and stable arrangement of at least one electric cable providing a winding structure of system for inductive power transfer, wherein the cable bearing arrangement is easy-to-install and easy-to-transport.

The solution to said technical problem is provided by the subject-matter with the features of claim 1 and claim 16. Further advantageous embodiments of the invention are provided by the subject-matter with the features of the sub claims.

A cable bearing arrangement for a winding structure of a system for inductive power transfer is proposed. The cable bearing arrangement is a cable bearing arrangement for a primary winding structure or for a secondary winding structure of the system for inductive power transfer. The system for inductive power transfer can be a system for transferring power to a vehicle travelling or standing on a surface of a route. The winding structure has a least a first cable.

The present invention can be applied to transfer energy to any land vehicle, in particular track-bound vehicles, such as rail vehicles (e.g. trams), but also to road automobiles, such as individual (private) passenger cars or public transport vehicles, e.g. buses. The cable bearing arrangement with a primary winding structure which produces the alternating electromagnetic field is integrated in a track or a road of the vehicle so that the electric lines of the primary side conductor arrangement extend in a plane which is nearly parallel to the surface of the road or track on which the vehicle may travel. The cable bearing arrangement with a secondary winding structure which receives the alternating electromagnetic field can be part of a pick-up device or receiving device and can be arranged at a bottom side of the vehicle.

The cable bearing arrangement comprises or provides at least one cable guiding means for holding at least the first cable. This means that the first cable can be arranged on or in the cable bearing arrangement.

If a cable is held by the cable bearing arrangement, a desired course or geometry of the cable can be provided by the at least one cable guiding means. In particular, at least one section of the cable can be fixed on or in a desired section of the cable bearing arrangement. Preferably, the cable bearing arrangement comprises multiple cable guiding means. By fixing different section of the cable to different desired section of the cable bearing arrangement, the desired geometry or course of the cable can be provided.

A cable can be or can provide at least one phase line of the winding structure. This means that the cable can carry at least one phase of a multiphase alternating current which generates an electromagnetic field or which is induced by an electromagnetic field.

Preferably, the cable bearing arrangement comprises or provides cable guiding means for more than one, in particular for three cables. These cable guiding means are designed and/or arranged such that a desired geometry of the multiple cables is provided, in particular such that a desired geometry of the winding structure is provided.

The cable bearing arrangement can have a longitudinal axis. In a rolled-out state or unfolded state of the cable bearing arrangement which will be explained in the following, the cable bearing arrangement can extend along the longitudinal axis. If the cable bearing arrangement is installed in or on a route, the longitudinal axis can be oriented parallel to a direction of travel of vehicles on the route if the vehicles travel straight forward. Further, a lateral axis can be assigned to the cable bearing arrangement. The lateral axis can be oriented orthogonal to the longitudinal axis. The longitudinal and the lateral axis can span a plane in which or parallel to which the cable bearing arrangement is arranged in the rolled out or unfolded state. Finally, a vertical axis can be assigned to the cable bearing arrangement. The vertical axis can be oriented or orthogonal to the longitudinal and lateral axis. The vertical axis can be oriented parallel to a gravitational force if the cable bearing arrangement is installed in or on a route.

If the cable is arranged in the desired geometry, a desired layout of the primary or secondary winding structure is provided. In this layout, an electromagnetic field with desired characteristics can be generated by the provided primary winding structure or received by the provided secondary winding structure.

According to the invention, the cable bearing arrangement is provided by a cable chain, wherein the cable chain can adopt an unrolled state and a rolled-up state. In other words, the cable chain can be put into an unrolled and into a rolled-up state. The unrolled state can also be referred to as unfolded state. A cable chain is also known as a drag chain and denotes an element designed to surround and guide flexible cables. Such a cable chain can enclose an inner volume with a rectangular cross section in which the cable is arranged. A cable chain can comprise multiple segments, wherein these segments are flexibly, in particular pivotally, attached to one another. The segments can also be referred to as cable chain elements. Further, the cable chain can comprise crossbars, wherein the crossbars can be arranged along the length of the cable chain. The crossbars can extend parallel to the lateral axis of the cable chain and can be attached to both longitudinal sidewalls of the cable chain. The crossbars can in particular provide a bottom side of the cable chain or a top side of the cable chain. Crossbars can e.g. be opened from the outside so that cables can be inserted into the inner volume of the cable chain. Further, the cable chain can comprise cable separating means for different cables arranged in the cable chain. Further, the cable chain can comprise a strain-relieve means for cables arranged in the cable chain.

The cable chain can be bent or rolled. A bending radius of the cable chain can be adapted to an admissible bending radius of the cables.

The aforementioned cable guiding means can also provide a cable separating means and/or strain-relieve means.

A chain pitch can denote the length of one segment of the cable chain. The chain pitch can be chosen such that a cable can be arranged with a desired bending radius in said segment, wherein the cable can be bent around an axis parallel to the vertical axis. A width of the cable chain can be equal to or larger than desired width of the primary or secondary winding structure. The minimal bending radius of the cable chain should be larger than the minimal admissible bending radius of the cable(s) arranged in the cable chain. Thus, the chain pitch should be adapted to a cable used for providing the winding structure. If, for instance, a minimal admissible bending radius of the cable is larger than or equal to 6 times an outer diameter of the cable, the minimal bending radius of cable chain should be larger than this minimal admissible bending radius of the cable.

Further, the cable guiding means can be designed and/or arranged such that a desired pitch between corresponding sections of multiple cables is provided. The pitch between corresponding sections can e.g. denote the distance along the longitudinal axis between a first cable or a section thereof and a second cable or a section thereof which is arranged adjacent to the first cable along the longitudinal axis. The pitch between corresponding sections and the phase shift between operating currents of the electric lines provided by the cables can define a so-called pole pitch between adjacent pole pairs along the longitudinal axis of winding structure provided by the arrangement of cables in the cable bearing arrangement. Under normal operating conditions, the electric line of the first cable can be energized by a first operating current wherein the electric line of the second cable can be energized by a second operating current. An electric line of the third cable structure can be energized by a third operating current. A phase shift between the first and the second operating current can be 120°, wherein a phase shift between a first and the third operating current can be 240°.

The usage of a cable chain as a cable bearing arrangement for a winding structure of a system for inductive power transfer advantageously provides a support for a precise and stable arrangement of the cable(s) used for providing the winding structure in a desired geometry wherein the resulting arrangement of cable bearing arrangement and cable(s) is portable, easy-to-transport and easy-to-install. In particular, the cable bearing arrangement can be used for the installation of a winding structure. The cable bearing arrangement allows holding one or more cables in place such that a desired layout of the primary or secondary winding structure is provided, in particular in the unrolled state.

Further advantages of the proposed solution are that the cable arrangement in the cable bearing arrangement can be assembled, tested and tuned in a factory. Further, delays of the installation due to bad weather conditions can be avoided, in particular if weather conditions do not allow the installation of cables in a cable bearing arrangement at the installation site, e.g. if it is too cold for cable installation.

Further, no tensile forces are exerted on the cable when the assembly is lifted or bended. Installation e.g. be done by rolling out cable chain, in particular with a special machine for installation. Alternatively, an in-situ installation of the cables by hand can be possible.

In comparison to prefabricated concrete slabs which comprise the winding structure, requirements of heavy lifting, transportation and installation are reduced, in particular because a light-weight arrangement is provided. Further, a transport is simplified as shorter resulting length of a bended cable chain can be provided. For the transport of cable bearing arrangements of shorter length, multiple flexible cable bearing arrangements can be stacked together in an unrolled state which results in a reduction of the transport costs. For the transport of cable bearing arrangements with longer length, the flexible cable chain can be rolled up which simplifies transportation. In summary, the cable bearing arrangement reduces a transportation effort within the process of providing a winding structure.

Further, cables arranged in the cable chain can be handled flexibly while undesired, in particular excessive, bending is avoided. Further, the installation of the cables in the cable bearing arrangement and the cable bearing arrangement on the route side requires less training for the installation personnel. This reduces the requirements or even the need for on side testing and supervision. Further, it is possible to provide multiple segments of the winding structure by different cable bearing arrangements. In this case, cable ends of cables within different cable chains can be easily connected to one another to provide overlapping segments of the winding structure.

In another embodiment, the cable bearing arrangement comprises a plurality of cable chain elements, wherein the cable chain elements are pivotally connected to each other. This has been explained before. A lower limit of a pivot angle between two connected cable chain elements is chosen such that a bend radius of at least the first cable is larger than or equal to a minimum bend radius if at least the first cable is arranged in the two connected chain elements. The lower limit of the pivot angle can be the pivot angle provided in the rolled-up state. A maximum pivot angle can be the pivot angle provided in the rolled-out state. This maximum pivot angle is preferably 180°. In this case, the two or more connected cable chain elements bearing the cable provide for an arrangement of the cable in a single plane.

A minimum bending radius of a cable with a cross sectional area of 60 mm² can e.g. be 105 mm. A minimum bending radius of a cable with a cross sectional area of 100 mm² can e.g. be 127 mm. A minimum bending radius of a cable with a cross sectional area of 120 mm² can e.g. be 136 mm. A minimum bending radius of a cable with a cross sectional area of 200 mm² can e.g. be 177 mm.

The length of the cable bearing arrangement should be chosen such that

$$a \geq \frac{r {sin}^{- 1} ( 180 - ( \frac{( n - 2 ) 180}{n} ) )}{{sin}^{- 1} ( \frac{( n - 2 ) 180}{2 n} )} , \qquad formula 1$$

wherein a denotes the length of the cable bearing arrangement, r denotes the minimum bending radius and n denotes the number of cable chain elements circumscribed in the circle of radius r.

This advantageously minimizes the risk of a cable damage during the transport and installation of the winding structure provided by the cable(s) held by the cable bearing arrangement.

In another embodiment, the cable guiding means are adapted such that at least one section of a first cable extends from a first longitudinal side of the cable bearing arrangement to a second longitudinal side of the cable bearing arrangement. This can mean that the cable guiding means are designed and/or arranged accordingly. In other words, at least one section of the first cable extends transverse to the longitudinal axis of the cable bearing arrangement. In yet other words, the at least one section of the first cable is spanned or spans from the first to the second longitudinal side.

More particular, the cable guiding means can be designed and/or arranged such that at least a first section of the first cable extends parallel to the longitudinal axis of the cable bearing arrangement and at least one further section of the first cable extends orthogonal to the longitudinal axis of the cable bearing arrangement, in particular parallel to the lateral axis.

In another embodiment, the cable guiding means are adapted, i.e. designed and/or arranged, such that the at least first cable is guidable with a meandering course. In other words, the cable(s) can be arranged in a meandering form, in particular in the unrolled state of the cable bearing arrangement. In other words, the first cable is guidable such that the cable can extend along the longitudinal axis of the cable chain in a serpentine manner. This can mean that sections of the cable which extend along the longitudinal axis are followed in each case by a section which extends transversely to the longitudinal direction which in turn are followed again by a section which extends along the longitudinal axis and so on. In case of a multiphase system, all cables can have a meandering course. Providing a meandering course of a cable in the cable bearing arrangement advantageously allows providing a primary winding structure which can generate a travelling electromagnetic field, wherein the electromagnetic field can travel along the longitudinal axis of cable bearing arrangement. Such an embodiment is particular useful for dynamic charging, i.e. for inductive power transfer to moving vehicles.

In an alternative embodiment, the cable guiding means are adapted, i.e. designed and/or arranged, such that the at least first cable is guidable along a course such that at least one section of the first cable provides at least one complete loop. In this case, the cable guiding means can guide the cable such that at least one conductor loop with one or multiple turns is provided. In other words, at least one section of the cable can be arranged in a circular form such that at least one complete loop of the winding structure is provided, in particular in the unrolled state of the cable bearing arrangement.

Such a design advantageously allows providing a winding structure which generates the electromagnetic field with desired characteristics in a desired charging region. It is thus particularly useful for static charging, i.e. for inductive power transfer to a vehicle at stop.

In another embodiment, the first cable provides at least two complete loops. Each loop can also be referred to as subwinding structure. Such a subwinding structure can provide a loop or a coil.

In this case, the cable can provide multiple subwinding structures which extend along the longitudinal axis of the cable bearing arrangement, which can be parallel to a longitudinal axis of the resulting winding structure. In this case, successive subwinding structures can be arranged adjacent to one another along said longitudinal axis. Adjacent to each other can mean that central axes of the subwindings, in particular, the axes of symmetry, are spaced apart from one another, e.g. with a predetermined distance along the longitudinal axis. A subwinding structure can be circular-shaped, oval-shaped or rectangular-shaped. Of course, other geometrical shapes are also possible.

Neighboring or adjacent subwindings can be counter-oriented. This can mean that a current flow in a first subwinding is oriented clockwise, wherein the current flow in the neighboring or adjacent subwinding is oriented counter-clockwise. The clockwise direction can be defined with respect to the parallel central axes which point into the same direction. If a current flows through the said subwindings, adjacent subwindings will generate a magnetic field of the same magnitude but oriented in opposite direction.

The subwinding structures can be flat subwinding structures, in particular flat loops or coils. This means that a subwinding is substantially arranged within a two-dimensional plane. Each subwinding structure can provide one pole of the respective phase line if the winding structure is energized with an alternating current.

Such an embodiment advantageously allows providing a winding structure with a high transfer efficiency.

In another embodiment, the cable guiding means are adapted to carry multiple cables. In this case, the cable bearing arrangement can comprise of provide cable guiding elements for multiple cables, in particular three cables. The cable guiding means are adapted, i.e. designed and/or arranged, such that different cables are guidable at different heights, in particular in the unrolled state of the cable bearing arrangement. The heights can be also referred to as vertical position. In this case, the cable guiding means allow to provide a winding structure with overlapping windings. This advantageously allows a compact design of the winding structure.

In another embodiment, a cable chain element comprises or provides at least one crossbar, wherein the cable guiding means are provided by or attached to the at least one crossbar. Alternatively or in addition, a cable guiding means can be provided by or attached to a longitudinal sidewall of the cable chain, in particular to a sidewall of one segment of the cable chain. This advantageously allows a simple and space saving provision of cable guiding means. It is possible that only selected but not all cable chain elements comprise or provide at least one crossbar.

In another embodiment, a cable guiding means is designed as a clamp. In particular, the cable guiding means can be designed as a nylon-type clamp.

A clamp can be set into an open state, wherein a cable can be inserted into the clamp in the open state. Further, the clamp can be set into a closed state, wherein an inserted cable is clamped in the closed state. Alternatively, a clamp can be a removable clamp. In this case, the cable can be clamped by the clamp if the clamp is attached to the cable chain.

Multiple clamps can be arranged on the cable chain in order to keep the cable in place and in order to reduce strain on the cable during rolling out of the cable chain.

This advantageously allows a stable a precise fixation of a cable section in or at a desired section of the cable chain.

In another embodiment, a cable guiding means allows a movable mounting of the cable. This can e.g. mean that the cable can slide through the cable guiding means. Such a sliding movement can e.g. be allowed if the cable bearing arrangement is set to the unrolled state. The cable guiding means can e.g. be a flexible clamp, wherein a flexible clamp allows a moveable mounting of the cable. This advantageously allows avoiding damage to the cable, in particular in the case that the cable chain is rolled up as the movable mounting of the cable provides a certain amount of flexibility in the cable guiding means.

In another embodiment, the cable bearing arrangement is made of non-metallic material. This advantageously minimizes an undesired influence of the cable bearing arrangement on the electro-magnetic field generated or received by the winding structure which is held by the cable bearing arrangement.

In another embodiment, the cable bearing arrangement has or provides at least one void. A void can also be denoted as blanking. Preferably, the bottom side and/or the top side of the cable chain comprises at least one, preferably more than one, void. In particular, the voids can be provided in between crossbars on the bottom side and/or the top side of the cable bearing arrangement. It is, of course, possible that a sidewall of the cable chain comprises or provides, at least one void.

The at least one void advantageously allows pavement material to flow through the void during the building of the road. Additionally, the voids provide a stable but light-weight cable bearing arrangement.

In another embodiment, the cable bearing arrangement comprises at least one magnetic flux guiding element. The magnetic flux guiding element can e.g. be a ferrite element. The magnetic flux guiding element can e.g. be designed as a bar, in particular a ferrite bar. The magnetic flux guiding element can be attached to a crossbar, in particular a crossbar providing a part of the bottom side of the cable bearing arrangement. Alternatively or in addition, the magnetic flux guiding element can be attached to a sidewall of the cable bearing arrangement, in particular to the sidewall of one segment of cable bearing arrangement.

Integrating a magnetic flux guiding element into the cable bearing arrangement advantageously allows guiding the electromagnetic field generated or received by the winding structure provided by the cable(s) in the cable bearing arrangement along a desired path.

In another embodiment, the cable bearing arrangement comprises at least one magnetic shielding element. The magnetic shielding element can e.g. be designed as an aluminum element. The magnetic shielding can e.g. be provided by a plate, in particular an aluminum plate. The magnetic shielding element can be attached to a bottom side of the cable bearing arrangement, in particular to crossbars arranged at the bottom side of the cable bearing arrangement.

Providing a magnetic shielding element advantageously allows shielding external electric or electronic elements in, on or above the route against the electromagnetic field used for inductive power transfer.

The cable bearing arrangement can comprise mounting means or reception means for attaching the magnetic flux guiding element and/or the magnetic shielding element to the cable bearing arrangement. Such mounting means can e.g. be arranged at or provided by the crossbars.

The magnetic flux guiding element and/or magnetic shielding element can e.g. be designed as a plate of provide a plate-like structure. The magnetic flux guiding element can e.g. be designed as a ferrite plate or a plate comprising multiple ferrite elements. The magnetic shielding element can e.g. be designed as an aluminium plate.

In another embodiment, the cable bearing arrangement comprises at least one spacer element. The spacer element can also be referred to as foot element of the cable bearing arrangement. The spacer element can be hinged at a bottom side of the cable bearing arrangement. In particular, a spacer element can extend from the bottom side of the cable bearing arrangement. Such a spacer element can be attached to the bottom side or to the cable bearing arrangement via a hinge. If the cable bearing arrangement is rolled out, such a spacer element can move into an extended position due to gravity. The spacer element can provide a desired distance between the electric cables in the cable bearing arrangement and a structure on which the cable bearing arrangement is installed. The structure can e.g. be a road foundation, a magnetic flux guiding element, in particular a plate-like flux guiding element, or magnetic shielding element, in particular a plate-like shielding element.

Further proposed is a method of installing a winding structure of a system for inductive power transfer, wherein the method comprises the following steps:
providing a cable bearing arrangement according to one of embodiments disclosed in this disclosure,
mounting at least a first cable to the cable bearing arrangement, in particular such that the first cable is held by the cable bearing arrangement,
arranging the cable bearing element on a ground.

The cable can be mounted to the cable bearing arrangement in an unrolled state of the cable bearing arrangement. It is then possible to roll up the cable bearing arrangement with the cable attached to it. Then, the cable bearing arrangement can be transported to an installation site in the rolled-up state. To install the winding structure on the ground, the cable bearing arrangement can be set into the rolled-out state on the ground. Further, the cable(s) can be connected to an electric power supply. It is, however, also possible to transport the cable bearing arrangement in the rolled-out state to the installation site. Further, pavement material can be casted onto and around the cable bearing arrangement. Such pavement material can flow through a void of the cable bearing arrangement during the building of the road. The cable bearing arrangement advantageously allows a simple transport and installation of a winding structure, in particular within or on the pavement. It is, however, also possible to install the cable bearing arrangement on a vehicle.

In another embodiment the cable bearing element is set into to a rolled-up state after at least the first cable is mounted to the cable bearing arrangement, wherein the cable bearing element is set into the unrolled state before or during arranging the cable bearing element on the ground. This and corresponding advantages have been described before.

In particular, the cable bearing arrangement can be rolled out along a longitudinal direction of the cable bearing arrangement. If the cable bearing arrangement comprises a plurality of cable chain elements which are pivotally connected to each other, these cable chain elements can allow rolling out the cable bearing arrangement on a construction site. Then, at least one cable can be mounted on cable guiding means of the cable bearing arrangement, wherein the cable bearing arrangement can be rolled up again in order to be transported to the installation site.

Further described is a method of manufacturing a cable bearing arrangement for a winding structure of a system for inductive power transfer. A cable chain is provided. A cable chain can e.g. be provided by providing multiple segments of the cable chain and connecting the segments movably, e.g. pivotally, to each other. Further, at least one cable guiding means for a first cable is provided, e.g. in form of a clamp. The cable guiding means can be an integral or a separate part with respect to the cable chain body. Further, the cable guiding means are designed and/or arranged such that at least one section of a first cable extends from a first longitudinal side of the cable bearing arrangement to a second longitudinal side of the cable bearing arrangement.

The described method advantageously allows providing a cable bearing arrangement according to one of the embodiments described in this invention. Thus, the method can comprise all steps necessary for providing such a cable bearing arrangement.

Further described is an arrangement of a cable bearing arrangement and at least one cable to provide a winding structure of the system for inductive power transfer. The cable bearing arrangement can be designed as a cable bearing arrangement according to one of the embodiments described in this invention. Further, the at least one cable can be arranged in the cable bearing arrangement, wherein at least one section of the cable is guided or hold by the at least one cable guiding means. In particular, the cable can be arranged in the cable bearing arrangement such that a desired geometry of a primary or secondary winding structure is provided by the cable. In particular, the cable can be arranged in the cable bearing arrangement such that the cable has a meandering course along the cable bearing arrangement or provides at least one or at least two complete loops.

Further described is a method for building a route for vehicles driving or standing on a surface of the route. The method comprises the steps of providing a cable bearing arrangement, arranging at least a first cable in the cable bearing arrangement and installing the cable bearing arrangement on a prepared base or foundation. Installation of the cable bearing arrangement can be done unrolling the cable bearing arrangement. Further, the method can comprise the step of casting pavement material onto or around the cable bearing arrangement.

Further described is a method for providing an inductive power transfer pad (charging pad) for vehicles standing above the IPT pad. The method comprises the steps of providing the cable bearing arrangement according to one of the embodiments disclosed in this invention and arranging at least a first cable in the cable bearing arrangement. Further the cable bearing arrangement can be installed in a housing of the IPT pad.

The invention will be described with reference to the attached figures. The figures show

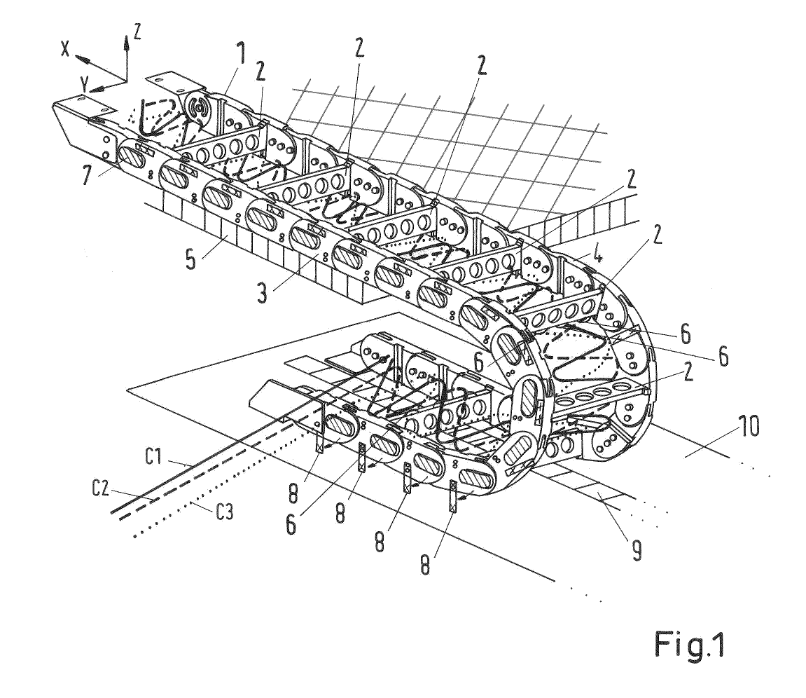

FIG. 1 a perspective view on a cable bearing arrangement according to the invention, and

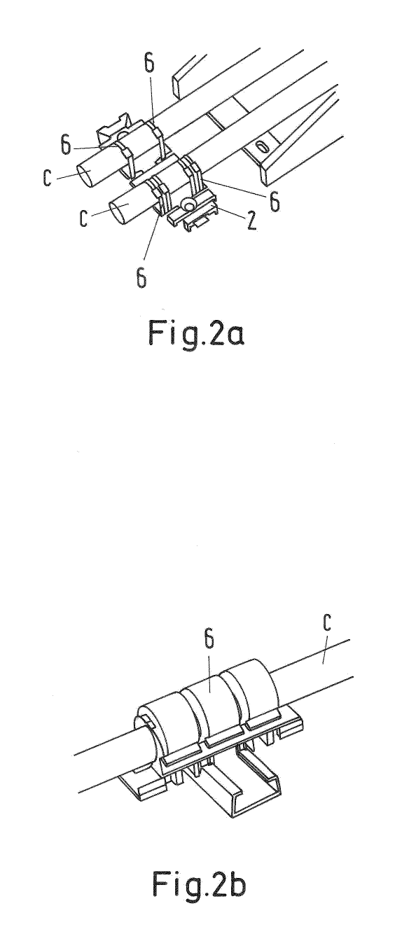

FIG. 2A a perspective view on the cable clamp in a first embodiment, and

FIG. 2B a perspective view on a cable clamp in a second embodiment.

FIG. 1 shows a perspective view of a cable bearing arrangement 1 according to the invention. The cable bearing arrangement 1 is designed as a cable chain, wherein the cable chain comprises multiple segments which are pivotally connected to one another. Further, the cable chain comprises crossbars 2 which extend from a first, left sidewall 3 to a second, right sidewall 4.

FIG. 1 shows that the cable bearing arrangement 1 during an installation of the cable bearing arrangement 1 under a pavement material 5. In particular, a two portions of the cable bearing arrangement 1 are in an unrolled state and a connecting portion of the cable bearing arrangement 1 is in a rolled up or folded state. The unrolled portion of the cable bearing arrangement 1 which is arranged under the pavement material 5 with respect to a vertical direction z is readily installed. The remaining unrolled section on the pavement material 5 and the bent section are not readily installed. These sections are installed by unrolling these sections along a direction oriented against a longitudinal direction x.

Further shown is a coordinate system of the cable bearing arrangement 1. Indicated is the longitudinal direction x along which a longitudinal axis of the cable bearing arrangement 1 extends in an unrolled state. Further indicated is a lateral axis y along which a lateral axis of the cable bearing arrangement 1 extends in an unrolled state. Further indicated is the vertical axis z along which a vertical axis of the cable bearing arrangement 1 extends in an unrolled state. It is shown that a portion of the cable bearing arrangement 1 is bent around an axis which is parallel to the lateral axis y.

Further shown are a first cable C1, a second cable C2 and a third cable C3, wherein each cable comprises an electric line which provides one of three phases of a multiphase structure. The first cable C1 is indicated with a solid line. The second cable C2 is indicated with a dashed line. The first cable C3 is indicated with a dotted line.

It is shown that all cables C1, C2, C3 are arranged in an inner volume of the cable chain, in particular in a volume between the sidewalls 3, 4. Further shown is that at the free end of the bent section of the cable chain 1, the cables C1, C2, C3 extend from outside into said inner volume Thus, cables C1, C2, C3 can be connected to a current or voltage source, in particular to a converter. In the inner volume, the cables C1, C2, C3 have a meandering course. In particular, each cable C1, C2, C3 extends along the longitudinal axis x in a serpentine manner. Corresponding sections of the cables C1, C2, C3 are displaced with a predetermined distance which generates a desired phase shift if an alternating current with a predetermined phase shift is supplied to the respective cables C1, C2, C3.

Further shown is that the unrolled section of the cable chain 1 is arranged on pavement material 5. Further shown are clamps 6 for clamping the cable sections of the cables C1, C2, C3 to a crossbar 2, in particular to a bottom side of the crossbars 2. It is shown that not all crossbars 2 have clamps 6 attached to it.

Further shown is that ferrite elements 7 are attached to the outer surfaces of the sidewalls of the segments of the cable chain 1, wherein only one ferrite element 7 is referenced with a reference numeral. Further shown are spacer elements 8 which are attached to an edge section of the sidewalls of the segments of the cable chain 1 via a hinge. If the edge section is oriented downwards with respect to the vertical direction z, the spacer elements 8 will fold out due to gravity.

Further shown are further ferrite elements 9 which provide a plate-like structure under the installed section of the cable chain. Further shown is an aluminum plate 10 which is arranged under the installed section of the cable chain and under the plate-like ferrite structure.

By using the spacer elements 8, a desired distance between the aluminium plate 10 and the cables C1, C2, C3 in the installed section of the cable bearing arrangement 1 can be provided, e.g. a distance larger than 0.0 m and up to 0.15 m.

The shown cable bearing arrangement 1 can be made of non-metallic material, in particular plastic.

Further shown is that crossbars 2 provide or have voids. Further, voids are provided between sidewalls 3, 4 of the cable chain.

FIG. 2A shows a perspective view on a cable clamp 6 in a first embodiment. Shown is a crossbar 2 to which ring-like clamps 6 are attached. Cables C extend through the volume enclosed by the ring-like clamps 6. A radius of the inner volume of the ring-like elements 6 can be smaller than, equal to or larger, in particular slightly larger, than an outer diameter of the cables C. If the diameter is equal to or (slightly) larger than the outer diameter of the cables C, the cables C are movably connected to the crossbar 2.

FIG. 2B shows a perspective view on a clamp another embodiment. Shown as a cable C which extends through an inner volume of a hollow-cylinder-like clamp 6. The cylinder-like clamp 6 can be hinged in order to arrange the cable C in the inner volume. Then the cylinder-like clamp 6 can be closed in order to fix the cable C.

1. A cable bearing arrangement for a winding structure of a system for inductive power transfer, the cable bearing arrangement comprising:
a cable bearing arrangement for a primary winding structure of the system for inductive power transfer which produces the alternating electromagnetic field or for a secondary winding structure of the system for inductive power transfer which receives the alternating electromagnetic field, wherein the winding structure has at least a first cable, wherein the cable bearing arrangement comprises or provides at least one cable guiding means for holding at least the first cable, wherein the cable guiding means is designed and/or arranged such that a desired geometry of at least the first cable is provided, wherein a desired layout of the primary or secondary winding structure is provided by at least the first cable being arranged in the desired geometry,
wherein the cable bearing arrangement is provided by a cable chain, wherein the cable chain is capable of adopting an unrolled state and a rolled-up state.

2. The cable bearing arrangement according to claim 1, wherein the cable bearing element comprises a plurality of cable chain elements, wherein the cable chain elements are pivotally connected to each other, wherein a lower limit of a pivot angle between two connected cable chain elements is chosen such that a bend radius of at least the first cable is larger than or equal to a minimum bend radius when at least the first cable is arranged in the two connected chain elements.

3. The cable bearing arrangement according to claim 1, wherein the at least one cable guiding means is adapted such that at least one section of a first cable extends from a first longitudinal side of the cable bearing arrangement to a second longitudinal side of the cable bearing arrangement.

4. The cable bearing arrangement according to claim 3, wherein the at least one cable guiding means is adapted such that the at least first cable is guidable with a meandering course.

5. The cable bearing arrangement according to claim 3, wherein the at least one cable guiding means is adapted such that at least the first cable is guidable along a course such that at least one section of the first cable provides at least one complete loop.

6. The cable bearing arrangement according to claim 5, wherein the first cable provides at least two complete loops.

7. The cable bearing arrangement according to claim 1, wherein the at least one cable guiding means is adapted to carry multiple cables, wherein the cable guiding elements are adapted such that the cables are guidable at different heights.

8. The cable bearing arrangement according to claim 1, wherein a cable chain element comprises or provides at least one crossbar, wherein the cable guiding means are provided by or attached to the at least one crossbar.

9. The cable bearing arrangement according to claim 1, wherein the at least one cable guiding means comprises a clamp.

10. The cable bearing arrangement according to claim 1, wherein the at least one cable guiding means allows a movable mounting of the cable.

11. The cable bearing arrangement according to claim 1, wherein the cable bearing arrangement is made of non-metallic material.

12. The cable bearing arrangement according to claim 1, wherein the cable bearing arrangement has or provides at least one void.

13. The cable bearing arrangement according to claim 1, wherein the cable bearing arrangement comprises at least one magnetic flux guiding element.

14. The cable bearing arrangement according to claim 1, wherein the cable bearing arrangement comprises at least one magnetic shielding element.

15. The cable bearing arrangement according to claim 1, wherein the cable bearing arrangement comprises at least one spacer element.

16. A method of installing a winding structure of a system for inductive power transfer, the method comprising:
providing a cable bearing arrangement according to claim 1;
mounting at least a first cable to the cable bearing arrangement; and
arranging the cable bearing arrangement on a ground.

17. The method of claim 16, further comprising moving the cable bearing arrangement to the rolled-up state after at least the first cable is mounted to the cable bearing arrangement, and
moving the cable bearing arrangement to the unrolled state before or during arranging the cable bearing arrangement on the ground.
